(19) United States
(12) Patent Application Publication
(10) Pub. No.: US 2011/0263887 A1
(43) Pub. Date: Oct. 27, 2011

(54) CYCLIC POLYORGANOSILOXANESILAZANE AND METHOD OF PRODUCING SAME

(76) Inventors: Kazuhiro Oishi, Annaka-shi (JP); Toshio Yamazaki, Annaka-shi (JP)

(21) Appl. No.: 13/094,030

(22) Filed: Apr. 26, 2011

(30) Foreign Application Priority Data
Apr. 27, 2010 (JP) 2010-102700

(51) Int. Cl. C07F 7/10

(52) U.S. Cl. 556/409

(57) ABSTRACT

A novel cyclic polyorganosiloxanesilazane, which is a siloxane oligomer having satisfactory reactivity, and is useful as a silylating agent that does not generate reaction residues. Also, a method of producing the cyclic polyorganosiloxanesilazane. The cyclic polyorganosiloxanesilazane is represented by general formula (1) shown below:

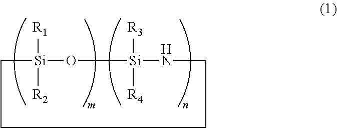

wherein R₁ to R₄ each represents an unsubstituted or substituted monovalent hydrocarbon group of 1 to 8 carbon atoms, m is an integer that satisfies 1≦m≦100 and n is an integer that satisfies 1≦n≦100, provided that m+n is an integer that satisfies 3≦m+n≦200, and the (SiR₁R₂O) units and (SiR₃R₄NH) units may be bonded randomly.

### BACKGROUND OF THE INVENTION

1. Field of the Invention

The present invention relates to a cyclic polyorganosiloxanesilazane and a method of producing the same.

2. Description of the Prior Art

Silylamines and silazane compounds containing a silylamino group are silylating agents that have a silylating action. This silylation property is applied in many fields, including silane coupling agents, the treatment of glass fiber, synthetic resin coating materials, adhesives, inorganic fillers and polishing agents. Further, these silylamines and silazane compounds react readily with organic compounds having an active hydrogen, such as alcohols, carboxylic acids, amines and mercaptans, resulting in improvements in the stability of these compounds, easier purification, and an improvement in the synthesis reaction yield.

In reactions of silylamines, basic amines are generated as by-products, and particularly in the case of silazane compounds, the by-product is volatile ammonia, and therefore the types of problems associated with silylating agents such as chlorosilane, including the generation of hydrochloric acid and the need to perform a treatment to neutralize this acid, resulting in the generation of hydrochloride by-products, do not arise.

Examples of known compounds that are widely used conventionally include monofunctional disilazanes in which three organic groups (non-hydrolyzable monovalent hydrocarbon groups, this definition also applies below) are bonded to each silicon atom, such as hexamethyldisilazane and 1,3-divinyl-1,1,3,3-tetramethyldisilazane, difunctional cyclosilazanes in which two organic groups are bonded to each silicon atom, such as 1,1,3,3,5,5-hexamethylcyclotrisilazane and 1,1,3,3,5,5,7,7-octamethylcyclotetrasilazane, and trifunctional silsesquiazanes in which one organic group is bonded to each silicon atom, such as methylsilsesquiazane (see Non-Patent Documents 1 and 2). The vast majority of these compounds effect silylation via a single silazane monomer having organic groups bonded to each silicon atom.

On the other hand, in cases where an oligomer or the like is subjected to a silylation treatment using a long-chain polyorganosiloxane, the use of halogen atoms, silanol groups and alkoxy groups as the terminal functional groups of the polyorganosiloxane is already known (see Non-Patent Documents 1 and 2). However, compared with silazanes, the reactivity of these compounds as silylating agents is not entirely satisfactory, and the removal step tends to generate troublesome reaction residues derived from the leaving groups.

### PRIOR ART DOCUMENTS

### Non-Patent Documents

Non-Patent Document 1: Silicone Handbook, edited by Kunio Ito, published Aug. 31, 1990 by Nikkan Kogyo Shimbun, Ltd.
Non-Patent Document 2: Protective Groups in Organic Synthesis, Third Edition, Theodora W. Greene, Peter G. M. Wuts, 1990, John Wiley & Sons, Inc.

### SUMMARY OF THE INVENTION

Accordingly, an object of the present invention is to provide a novel cyclic polyorganosiloxanesilazane, which is a siloxane oligomer having satisfactory reactivity, and is useful as a silylating agent that does not generate reaction residues, and to provide a method of producing the cyclic polyorganosiloxanesilazane.

As a result of intensive investigation aimed at achieving the above object, the inventors of the present invention developed a novel cyclic polyorganosiloxanesilazane composed of a siloxane unit and a silazane unit, and they discovered that this compound was capable of addressing the problems outlined above.

In other words, a first aspect of the present invention provides:

a cyclic polyorganosiloxanesilazane represented by general formula (1) shown below:

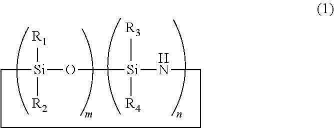

(wherein R₁ to R₄ each represents an unsubstituted or substituted monovalent hydrocarbon group of 1 to 8 carbon atoms, m is an integer that satisfies 1≦m≦100 and n is an integer that satisfies 1≦n≦100, provided that m+n is an integer that satisfies 3≦m+n≦200, and the (SiR₁R₂O) units and (SiR₃R₄NH) units may be bonded randomly).

Further, another aspect of the present invention provides a method of producing the above cyclic polyorganosiloxanesilazane, the method comprising:

reacting a cyclic polyorganosiloxane represented by general formula (2) shown below:

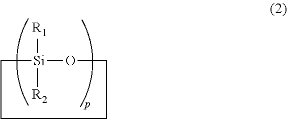

(wherein R₁ and R₂ each represents an unsubstituted or substituted monovalent hydrocarbon group of 1 to 8 carbon atoms, and p is an integer that satisfies 3≦p≦100), and a dihydrocarbyldihalosilane represented by general formula (3) shown below:

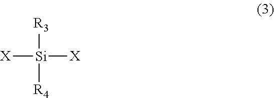

(wherein R₃ and R₄ each represents an unsubstituted or substituted monovalent hydrocarbon group of 1 to 8 carbon atoms, and X represents a halogen atom) in the presence of a strong acid catalyst, in a reaction that results in ring-opening of the cyclic polyorganosiloxane represented by general formula (2), thereby synthesizing a linear polyorganosiloxane with both molecular chain terminals blocked with halogen atoms, and

diluting the obtained reaction mixture by adding a solvent, thereby dissolving the linear polyorganosiloxane, and subsequently passing excess ammonia through the obtained reaction liquid, thus producing the cyclic polyorganosiloxanesilazane represented by general formula (1) defined in the first aspect.

Moreover, yet another aspect of the present invention provides an alternative method of producing the cyclic polyorganosiloxanesilazane, the method comprising:

reacting a cyclic polyorganosiloxane represented by general formula (2) shown below:

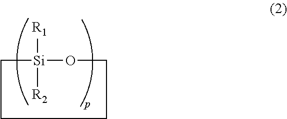

(wherein R₁ and R₂ each represents an unsubstituted or substituted monovalent hydrocarbon group of 1 to 8 carbon atoms, and p is an integer that satisfies 3≦p≦100), and a dihydrocarbyldihalosilane represented by general formula (3) shown below:

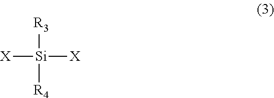

(wherein R₃ and R₄ each represents an unsubstituted or substituted monovalent hydrocarbon group of 1 to 8 carbon atoms, and X represents a halogen atom) in the presence of a Lewis base catalyst, in a reaction that results in ring-opening of the cyclic polyorganosiloxane represented by general formula (2), thereby synthesizing a linear polyorganosiloxane with both molecular chain terminals blocked with halogen atoms, and

diluting the obtained reaction mixture by adding a solvent, thereby dissolving the linear polyorganosiloxane, and subsequently passing excess ammonia through the obtained reaction liquid, thus producing the cyclic polyorganosiloxanesilazane represented by general formula (1) defined in the first aspect.

In the cyclic polyorganosiloxanesilazane of the present invention, the introduction of silazane bonds into a siloxane oligomer yields a compound that can be used as a highly reactive silylating agent. Further, the problem of reaction residues does not arise.

### DETAILED DESCRIPTION OF THE PREFERRED EMBODIMENTS

### <Cyclic Polyorganosiloxanesilazane>

A cyclic polyorganosiloxanesilazane of the present invention is a compound represented by general formula (1) shown below.

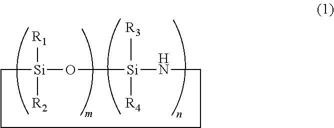

In the above formula, R₁ to R₄ each represents an unsubstituted or substituted monovalent hydrocarbon group of 1 to 8 carbon atoms, m is an integer that satisfies 1≦m≦100 and n is an integer that satisfies 1≦n≦100, provided that m+n is an integer that satisfies 3≦m+n≦200, and the (SiR₁R₂O) units and (SiR₃R₄NH) units may be bonded randomly.

The groups R₁, R₂, R₃ and R₄ are unsubstituted or substituted monovalent hydrocarbon groups of 1 to 8 carbon atoms, examples of which include alkyl groups such as a methyl group, ethyl group, propyl group, isopropyl group or butyl group, alkenyl groups such as a vinyl group or allyl group, aryl groups such as a phenyl group or tolyl group, and groups in which some or all of the hydrogen atoms bonded to carbon atoms within the above groups have been substituted with halogen atoms or a cyano group or the like, such as a chloromethyl group, 3,3,3-trifluoropropyl group or 2-cyanoethyl group. Monovalent hydrocarbon groups of 1 to 6 carbon atoms are preferred, and a methyl group, 3,3,3-trifluoropropyl group or vinyl group is particularly desirable.

Further, m is an integer that satisfies 1≦m≦100, preferably satisfies 1≦m≦50, more preferably satisfies 1≦m≦30, still more preferably satisfies 1≦m≦20, and most preferably satisfies 1≦m≦10. n is an integer that satisfies 1≦n≦100, preferably satisfies 1≦n≦50, more preferably satisfies 1≦n≦30, still more preferably satisfies 1≦n≦20, and most preferably satisfies 1≦n≦10. Furthermore, the value of m+n is an integer that satisfies 3≦m+n≦200, preferably satisfies 3≦m+n≦100, more preferably satisfies 3≦m+n≦60, still more preferably satisfies 3≦m+n≦40, and most preferably satisfies 3≦m+n≦20.

### <Production Method>

The two production methods of the present invention each includes (A) a ring-opening synthesis reaction step, and (B) a silazanation reaction step.

In the first production method:

(A) a cyclic polyorganosiloxane represented by general formula (2) shown below:

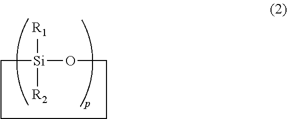

(wherein R₁ and R₂ are the same as defined above, and p is an integer that satisfies 3≦p≦100),
and a dihydrocarbyldihalosilane represented by general formula (3) shown below:

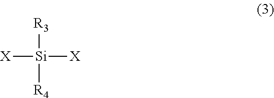

(wherein R₃ and R₄ are the same as defined above, and X represents a halogen atom) are reacted in the presence of a strong acid catalyst, in a reaction that results in ring-opening of the cyclic polyorganosiloxane represented by general formula (2), thereby synthesizing a linear polyorganosiloxane with both molecular chain terminals blocked with halogen atoms, and
(B) the obtained reaction mixture comprising the linear polyorganosiloxane with both molecular chain terminals blocked with halogen atoms is diluted by adding a solvent, thereby dissolving the linear polyorganosiloxane, and excess ammonia is then passed through the obtained reaction liquid to effect a silazanation.

Subsequently, purification is usually conducted by removing by-product salts by filtration, and then removing the solvent by heating under reduced pressure.

With the exception of using a Lewis base instead of the strong acid catalyst in the above-mentioned step (A), the second production method of the present invention is basically the same as the first production method.

### —(A) Ring-Opening Synthesis Reaction—

In general formulas (2) and (3), R₁, R₂, R₃ and R₄ are the same as defined above.

p is an integer that satisfies 3≦p≦100, preferably satisfies 3≦p≦50, more preferably satisfies 3≦p≦30, still more preferably satisfies 3≦p≦20, and most preferably satisfies 3≦p≦10.

X represents a halogen atom such as a chlorine atom, bromine atom or iodine atom, and is most preferably a chlorine atom.

In the above reaction that results in ring-opening, the polymerization degree of the resulting cyclic polyorganosiloxanesilazane represented by general formula (1) and the values of m and n are determined by the molar ratio between the cyclic polyorganosiloxane represented by general formula (2) and the dihydrocarbyldihalosilane represented by general formula (3).

In terms of the ring-opening reaction catalyst, a strong acid is used in the first production method, whereas a Lewis base is used in the second production method.

Catalyst: Strong Acid

Conventional acids can usually be used as the strong acid, and although there are no particular limitations, typical examples include concentrated sulfuric acid, trifluoromethanesulfonic acid, methanesulfonic acid, concentrated nitric acid, hydrochloric acid, p-toluenesulfonic acid, trifluoroacetic acid, trichloroacetic acid, dichloroacetic acid, aluminum chloride and boron trifluoride diethyl ether complex, and of these, concentrated sulfuric acid is preferred. If the ring-opening of the cyclic polyorganosiloxane represented by general formula (2) is performed using an acid having an acidity that is too high, then an intramolecular cyclization may occur prior to the reaction with the dialkyldihalosilane, meaning the linear polyorganosiloxane with both molecular chain terminals blocked with halogen atoms is not produced. In contrast, if the acidity of the acid catalyst is too low, then the ring-opening reaction of the cyclic polyorganosiloxane represented by general formula (2) tends to slow.

In those cases where a strong acid is used, although there are no particular limitations on the amount added of the strong acid, the amount is typically within a range from 0.001 to 100 mass %, and preferably from 0.05 to 70 mass % of the combined mass of the cyclic polyorganosiloxane represented by general formula (2) and the dihydrocarbyldihalosilane represented by general formula (3).

In terms of the ring-opening reaction conditions employed when an above-mentioned strong acid is used, the reaction may be conducted, for example, at room temperature (namely, 25° C.±10° C.) for a reaction time of approximately 2 hours or longer. While the upper limit of the reaction time is not limited, normally a time of 48 hours is sufficient. Preferably 5 to 24 hours.

In order to prevent the hydrogen chloride that is generated during the reaction from being released outside the system, the reaction vessel is preferably either a sealed system or a pressurized vessel. In the case where a strong acid is used as the catalyst, the reaction between the cyclic polyorganosiloxane represented by general formula (2) and the dihydrocarbyldihalosilane represented by general formula (3) is preferably carried out in a sealed reaction vessel for progress of the reaction.

Catalyst: Lewis Base

Conventional compounds can usually be used as the Lewis base, and although there are no particular limitations, typical examples include hexamethylphosphoric triamide (HMPA), pyridine-N-oxide, 2,6-dichloropyridine-N-oxide, 4-dimethylaminopyridine-N-oxide, dimethylsulfoxide, dimethylformamide, 1,3-dimethyl-2-imidazolidinone and 1,3-dimethyl-3,4,5,6-tetrahydro-2(1H)-pyrimidinone. HMPA is preferred from the viewpoints of reaction time and product purity, but because HMPA is a carcinogenic substance and can therefore not be used industrially, 1,3-dimethyl-3,4,5,6-tetrahydro-2(1H)-pyrimidinone is preferred.

In those cases where a Lewis base is used, although there are no particular limitations on the amount added of the Lewis base, the amount is typically within a range from 0.001 to 100 mass %, and preferably from 0.05 to 70 mass % of the combined mass of the cyclic polyorganosiloxane represented by general formula (2) and the dihydrocarbyldihalosilane represented by general formula (3).

In terms of the ring-opening reaction conditions employed when a Lewis base is used, the reaction may be conducted, for example, at room temperature (namely, 25° C.±10° C.) for a reaction time of approximately 5 hours or longer. While the upper limit of the reaction time is not limited, normally a time of 72 hours is sufficient. Preferably 7 to 48 hours.

### —(B) Silazanation Reaction—

There are no particular limitations on the diluting solvent used when conducting the silazanation reaction, and conventional solvents can usually be used. Specific examples of the diluting solvent include hexane, heptane, octane, nonane, decane, undecane, dodecane, toluene, xylene, tetrahydrofuran, diethyl ether, cyclopentyl methyl ether, acetonitrile, dichloromethane, dichloroethane, chloroform, acetone and methyl ethyl ketone, and of these, heptane and toluene are preferred. If the solvent boiling point is too low, then the solvent tends to volatilize when the ammonia gas is passed through the reaction liquid, whereas if the boiling point is too high, then separation of the solvent from the produced cyclic silazane becomes problematic.

In terms of the reaction conditions employed during the silazanation reaction described above, the reaction may be conducted, for example, in an ice bath (namely, 0° C.±10° C.) or at room temperature (namely, 25° C.±10° C.), by passing ammonia gas through the reaction liquid for a period of approximately 10 minutes or longer. The upper limit of the reaction time is not limited, but normally a time of 24 hours is sufficient. Preferably 30 minutes to 12 hours, and more preferably 1 to 6 hours.

Following this silazanation reaction, the reaction mixture is usually stirred under heat (for example, 40 to 100° C., and preferably 50 to 80° C.) to volatilize the excess ammonia gas, subsequently cooled to room temperature, and then filtered to remove by-product salts.

Moreover, following the above filtration operation, the solvent and any neutral by-products such as ammonium salts are usually removed by heating under reduced pressure.

### EXAMPLES

### Example 1

### Synthesis of Cyclic Polyorganosiloxanesilazane (1)

A sealed vessel (1.5 L) was charged with hexamethylcyclotrisiloxane (542.03 g, 2.44 mol, 1.0 equivalent), dimethyldichlorosilane (404.13 g, 2.69 mol, 1.1 equivalents) and concentrated sulfuric acid (47.31 g, 0.37 mol, 5 mass %), and the resulting mixture was stirred under a nitrogen atmosphere at room temperature for 12 hours. Subsequently, the thus obtained crude product was transferred to a 5 L three-neck separable flask and dissolved in heptane (2 L). The resulting solution was cooled to 5° C. using an ice bath, and excess ammonia gas was then passed through the solution for a period of 8 hours to effect a reaction. Following completion of the reaction, the reaction liquid was stirred for 2 hours at 60° C. to volatilize the excess ammonia gas, and the reaction liquid was then cooled to room temperature and filtered to remove by-product salts. Subsequently, the solvent and any neutral by-products such as ammonium salts were removed from the filtrate by heating under reduced pressure, yielding a cyclic polyorganosiloxanesilazane (1) (628.47 g). The components within the product were attributed on the basis of GC-MS analysis, and the following results were obtained.

The compound of formula (4) below: 1.23%, the compound of formula (5): 37.78%, the compound of formula (6): 16.41%, the compound of formula (7): 19.35%, the compound of formula (8): 10.65%, the compound of formula (9): 6.83%, the compound of formula (10): 2.44%, hexamethylcyclotrisiloxane: 1.98%, and octamethylcyclotetrasiloxane: 3.33%.

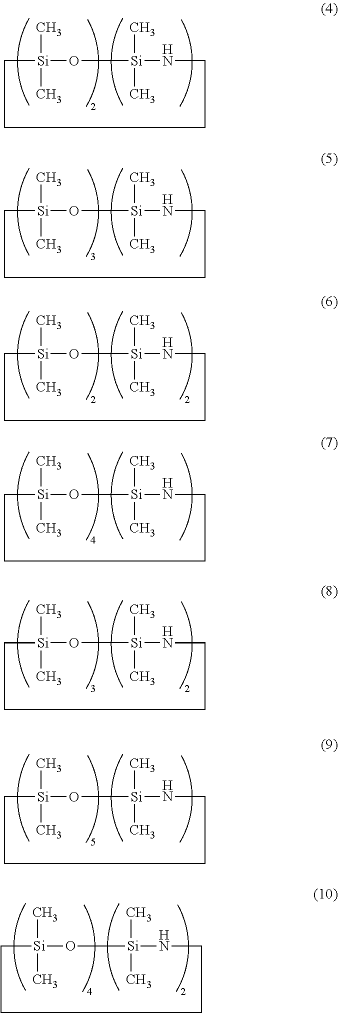

(In each of formulas (6), (8) and (10), the siloxane units and silazane units that constitute the compound exist in a random arrangement.)

### Example 2

### Synthesis of Cyclic Polyorganosiloxanesilazane (2)

A 1 L three-neck separable flask was charged with hexamethylcyclotrisiloxane (222.44 g, 1.0 mol, 1.0 equivalent), dimethyldichlorosilane (135.62 g, 1.05 mol, 1.05 equivalents) and hexamethylphosphoric triamide (174 μL, 0.001 mol), and the resulting mixture was stirred under a nitrogen atmosphere at room temperature for 3 hours. Subsequently, the thus obtained crude product was dissolved in toluene (716 g), the resulting solution was cooled to 5° C. using an ice bath, and excess ammonia gas was passed through the solution for a period of 8 hours to effect a reaction. Following completion of the reaction, the reaction solution was stirred for 2 hours at 60° C. to volatilize the excess ammonia gas, and the reaction solution was then cooled to room temperature and filtered to remove by-product salts. Subsequently, the solvent and any neutral by-products such as ammonium salts were removed from the filtrate by heating under reduced pressure, yielding a cyclic polyorganosiloxanesilazane (2). GC-MS analysis confirmed that 250.22 g (overall yield: 84.7%) of the compound represented by formula (11) shown below had been obtained.

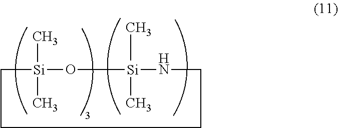

### Example 3

### Synthesis of Cyclic Polyorganosiloxanesilazane (3)

A 5 L three-neck separable flask was charged with tris(3,3,3-trifluoropropyl)trimethylcyclotrisiloxane (777.76 g, 1.66 mol, 1.0 equivalent), dimethyldichlorosilane (236.59 g, 1.83 mol, 1.1 equivalents) and 1,3-dimethyl-3,4,5,6-tetrahydro-2(1H)-pyrimidinone (2.15 g, 0.017 mol, 0.01 equivalents), and the resulting mixture was stirred under a nitrogen atmosphere at room temperature for 12 hours. Subsequently, the thus obtained crude product was dissolved in toluene (2 kg), the resulting solution was cooled to 5° C. using an ice bath, and excess ammonia gas was passed through the solution for a period of 6 hours to effect a reaction. Following completion of the reaction, the reaction solution was stirred for 2 hours at 60° C. to volatilize the excess ammonia gas, and the reaction solution was then cooled to room temperature and filtered to remove by-product salts. Subsequently, the solvent and any neutral by-products such as ammonium salts were removed from the filtrate by heating under reduced pressure, yielding a cyclic polyorganosiloxanesilazane (3). GC-MS analysis confirmed that 799.36 g (overall yield: 89.1%) of the compound represented by formula (12) shown below had been obtained.

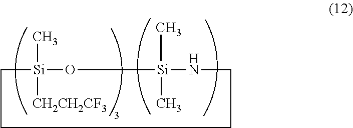

### Comparative Example 1

### Synthesis of Cyclic Polyorganosiloxanesilazane (4)

A 2 L three-neck separable flask was charged with hexamethylcyclotrisiloxane (542.03 g, 2.44 mol, 1.0 equivalent), dimethyldichlorosilane (404.13 g, 2.69 mol, 1.1 equivalents) and concentrated sulfuric acid (53.06 g, 0.41 mol, 5 mass %), and the resulting mixture was stirred under a stream of nitrogen at room temperature for 12 hours. Tracking of the reaction by gas chromatography revealed that the dimethyldichlorosilane had not been eliminated, and no reaction progression was able to be confirmed.

The cyclic polyorganosiloxanesilazane of the present invention is useful as a silylating agent.

What is claimed is:

1. A cyclic polyorganosiloxanesilazane represented by general formula (1) shown below: 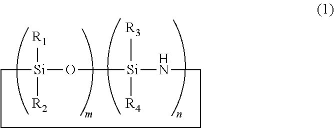
wherein R₁ to R₄ each represents an unsubstituted or substituted monovalent hydrocarbon group of 1 to 8 carbon atoms, m is an integer that satisfies 1≦m≦100 and n is an integer that satisfies 1≦n≦100, provided that m+n is an integer that satisfies 3≦m+n≦200, and (SiR₁R₂O) units and (SiR₃R₄NH) units may be bonded randomly.

2. A method of producing a cyclic polyorganosiloxanesilazane, the method comprising:
reacting a cyclic polyorganosiloxane represented by general formula (2) shown below: 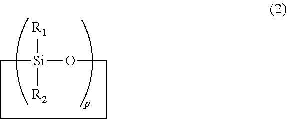
wherein R₁ and R₂ each represents an unsubstituted or substituted monovalent hydrocarbon group of 1 to 8 carbon atoms, and p is an integer that satisfies 3≦p≦100, and a dihydrocarbyldihalosilane represented by general formula (3) shown below: 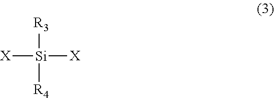
wherein R₃ and R₄ each represents an unsubstituted or substituted monovalent hydrocarbon group of 1 to 8 carbon atoms, and X represents a halogen atom, in presence of a strong acid catalyst, in a reaction that results in ring-opening of the cyclic polyorganosiloxane represented by general formula (2), thereby synthesizing a linear polyorganosiloxane with both molecular chain terminals blocked with halogen atoms, and
diluting an obtained reaction mixture by adding a solvent, thereby dissolving the linear polyorganosiloxane, and subsequently passing excess ammonia through a resulting reaction liquid, thus producing the cyclic polyorganosiloxanesilazane represented by general formula (1) defined in claim 1.

3. The method of producing a cyclic polyorganosiloxanesilazane according to claim 2, wherein the strong acid catalyst is at least one acid selected from the group consisting of concentrated sulfuric acid, trifluoromethanesulfonic acid, methanesulfonic acid, concentrated nitric acid, hydrochloric acid, p-toluenesulfonic acid, trifluoroacetic acid, trichloroacetic acid, dichloroacetic acid, aluminum chloride and boron trifluoride diethyl ether complex.

4. The method of producing a cyclic polyorganosiloxanesilazane according to claim 3, wherein the strong acid catalyst is concentrated sulfuric acid.

5. The method of producing a cyclic polyorganosiloxanesilazane according to claim 2, wherein the ring-opening of the cyclic polyorganosiloxane represented by general formula (2) is conducted under ring-opening reaction conditions including a room temperature reaction and a reaction time of 2 hours or longer.

6. The method of producing a cyclic polyorganosiloxanesilazane according to claim 2, wherein an amount added of the strong acid catalyst is within a range from 0.001 to 100 mass % of a combined mass of the cyclic polyorganosiloxane represented by general formula (2) and the dihydrocarbyldihalosilane represented by general formula (3).

7. The method of producing a cyclic polyorganosiloxanesilazane according to claim 2, wherein X in general formula (3) represents a chlorine atom.

8. The method of producing a cyclic polyorganosiloxanesilazane according to claim 2, wherein following production of the cyclic polyorganosiloxanesilazane represented by general formula (1) in the form of a reaction mixture, by-product salts are removed from the reaction mixture by filtration, and the solvent is then removed by heating under reduced pressure.

9. The method of producing a cyclic polyorganosiloxanesilazane according to claim 2, wherein the cyclic polyorganosiloxane represented by general formula (2) and the dihydrocarbyldihalosilane represented by general formula (3) are allowed to react in a sealed reaction vessel.

10. A method of producing a cyclic polyorganosiloxanesilazane, the method comprising:
reacting a cyclic polyorganosiloxane represented by general formula (2) shown below: 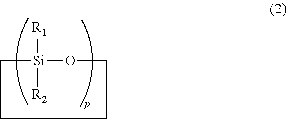
wherein R₁ and R₂ each represents an unsubstituted or substituted monovalent hydrocarbon group of 1 to 8 carbon atoms, and p is an integer that satisfies 3≦p≦100, and a dihydrocarbyldihalosilane represented by general formula (3) shown below: 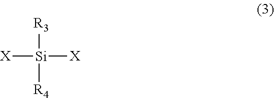
wherein R₃ and R₄ each represents an unsubstituted or substituted monovalent hydrocarbon group of 1 to 8 carbon atoms, and X represents a halogen atom, in presence of a Lewis base catalyst, in a reaction that results in ring-opening of the cyclic polyorganosiloxane represented by general formula (2), thereby synthesizing a linear polyorganosiloxane with both molecular chain terminals blocked with halogen atoms, and
diluting a reaction mixture thus obtained by adding a solvent, thereby dissolving the linear polyorganosiloxane, and subsequently passing excess ammonia through a resulting reaction liquid, thus producing the cyclic polyorganosiloxanesilazane represented by general formula (1) defined in claim 1.

11. The method of producing a cyclic polyorganosiloxanesilazane according to claim 10, wherein the Lewis base catalyst is at least one compound selected from the group consisting of hexamethylphosphoric triamide, pyridine-N-oxide, 2,6-dichloropyridine-N-oxide, 4-dimethylaminopyridine-N-oxide, dimethylsulfoxide, dimethylformamide, 1,3-dimethyl-2-imidazolidinone and 1,3-dimethyl-3,4,5,6-tetrahydro-2(1H)-pyrimidinone.

12. The method of producing a cyclic polyorganosiloxanesilazane according to claim 10, wherein the Lewis base catalyst is hexamethylphosphoric triamide.

13. The method of producing a cyclic polyorganosiloxanesilazane according to claim 10, wherein the ring-opening of the cyclic polyorganosiloxane represented by general formula (2) is conducted under ring-opening reaction conditions including a room temperature reaction and a reaction time of 5 hours or longer.

14. The method of producing a cyclic polyorganosiloxanesilazane according to claim 10, wherein an amount added of the Lewis base catalyst is within a range from 0.001 to 100 mass % of a combined mass of the cyclic polyorganosiloxane represented by general formula (2) and the dihydrocarbyldihalosilane represented by general formula (3).

15. The method of producing a cyclic polyorganosiloxanesilazane according to claim 10, wherein X in general formula (3) represents a chlorine atom.

16. The method of producing a cyclic polyorganosiloxanesilazane according to claim 10, wherein following production of the cyclic polyorganosiloxanesilazane represented by general formula (1) in the form of a reaction mixture, by-product salts are removed from the reaction mixture by filtration, and the solvent is then removed by heating under reduced pressure.
